(19) United States
(12) Patent Application Publication
(10) Pub. No.: US 2025/0164625 A1
(43) Pub. Date: May 22, 2025

(54) OBJECT DETECTION DEVICE AND OBJECT DETECTION METHOD

(71) Applicant: DENSO CORPORATION, Kariya-city (JP)

(72) Inventors: Shogo NAKAMURA, Nisshin-city (JP); Yu KOYAMA, Nisshin-city (JP); Tetsuya AOYAMA, Kariya-city (JP)

(21) Appl. No.: 19/035,418

(22) Filed: Jan. 23, 2025

Related U.S. Application Data
(63) Continuation of application No. PCT/JP2023/025441, filed on Jul. 10, 2023.

(30) Foreign Application Priority Data
Jul. 26, 2022 (JP) 2022-118988

(51) Int. Cl. G01S 7/524; G01S 15/58; G01S 15/931

(52) U.S. Cl. CPC G01S 7/524; G01S 15/582; G01S 15/931

(57) ABSTRACT

An object detection device has a transmitter that transmits a long pulse signal, in which a pulse width is longer than a predetermined time, as a transmission wave, the transmission wave being an ultrasonic wave; a receiver that obtains a received signal corresponding to a reflected wave reflected by an object of the transmission wave; a signal processor that obtains a fluctuation signal based on the received signal and detects the object based on the fluctuation signal, wherein the fluctuation signal is a signal corresponding to a composite wave generated when receiving the reflected wave and a wave which frequency is different from the reflected wave, or a signal generated by a phase change of the reflected wave when the distance to the object changes.

### CROSS-REFERENCE TO RELATED APPLICATIONS

The present application is a continuation application of International Application No. PCT/JP2023/025441, filed on Jul. 10, 2023, which claims priority to Japanese Application No. 2022-118988, filed on Jul. 26, 2022. The contents of these applications are incorporated herein by reference in their entirety.

### BACKGROUND

### 1. Technical Field

The present disclosure relates to an object detection device and an object detection method.

### 2. Related Art

Conventionally, a thermally excited sonar is known (see, for example, JP4826392B2). This sonar transmits a frequency-modulated transmission wave in a 10 kHz to 50 kHz band and determines whether the object is a person based on the frequency characteristics of the reflected wave reflected by the object.

### SUMMARY

According to one aspect of the present disclosure, an object detection device includes: a transmitter that transmits a long pulse signal, in which a pulse width is longer than a predetermined time, as a transmission wave, the transmission wave being an ultrasonic wave, a receiver that obtains a received signal corresponding to a reflected wave reflected by an object of the transmission wave, a signal processor that obtains a fluctuation signal based on the received signal and detects the object based on the fluctuation signal. The fluctuation signal is a signal corresponding to a composite wave generated when receiving the reflected wave and a wave which frequency is different from the reflected wave, or a signal generated by a phase change of the reflected wave when the distance to the object changes.

According to another aspect of the present disclosure, an object detection method includes: transmitting a long pulse signal, in which a pulse width is longer than a predetermined time, as a transmission wave, the transmission wave being an ultrasonic wave, acquiring a received signal corresponding to a reflected wave reflected by an object of the transmission wave, obtaining a fluctuation signal based on the received signal, and detecting the object based on the fluctuation signal. The fluctuation signal is a signal corresponding to a composite wave generated when receiving the reflected wave and a wave which frequency is different from the reflected wave, or a signal generated by a phase change of the reflected wave when the distance to the object changes.

### BRIEF DESCRIPTION OF THE DRAWING

FIG. 1 is a schematic diagram of a vehicle equipped with an in-vehicle system including an object detection device according to the first embodiment.

FIG. 2 is a block diagram showing the schematic functional configuration of the in-vehicle system of the first embodiment.

FIG. 3 illustrates the received wave.

FIG. 4 illustrates the composite wave of the transmission wave and the reflected wave.

FIG. 5 illustrates the changes in the amplitude of the composite wave due to vibration and microtremors of the object.

FIG. 6 illustrates the amplitude change of the composite wave caused by the movement of an object.

FIG. 7 illustrates the signal transmitted from the transmitter.

FIG. 8 illustrates the received signal received by the receiver.

FIG. 9 illustrates the received signal at the receiver when a short pulse signal is transmitted as a transmission wave.

FIG. 10 illustrates the received signal at the receiver when a long pulse signal is transmitted as a transmission wave.

FIG. 11 illustrates the pulse width of the long pulse signal.

FIG. 12 illustrates the results of estimating the pulse width and the speed of an object in which the object is detected.

FIG. 13 illustrates the amplitude waveforms of the signal components in the fluctuation signal when the long pulse signal is used as a transmission wave.

FIG. 14 illustrates the amplitude waveform of the average of the squares of the signal components in the fluctuation signal when the long pulse signal is used as a transmission wave.

FIG. 15 illustrates how to calculate the speed of an object based on the Doppler shift frequency.

FIG. 16 is a block diagram showing the schematic functional configuration of the in-vehicle system of the second embodiment.

FIG. 17 illustrates the effect of directly received transmission waves on received waves.

FIG. 18 illustrates the effect of directly received transmission waves on the fluctuation signals.

FIG. 19 is a block diagram showing the schematic functional configuration of the in-vehicle system of the third embodiment.

FIG. 20 illustrates the transmission wave of the in-vehicle system of the fourth embodiment.

FIG. 21 illustrates the amplification ratio of the long pulse signal and short pulse signal in the in-vehicle system of the fourth embodiment.

FIG. 22 illustrates the transmission wave of the in-vehicle system according to the fifth embodiment.

FIG. 23 is a block diagram showing the schematic functional configuration of the in-vehicle system according to the sixth embodiment.

FIG. 24 is a flowchart showing the flow of control process performed by the drive control unit.

### DETAILED DESCRIPTION OF THE PREFERRED EMBODIMENTS

The reflectivity of humans to ultrasonic waves is low, and interference between reflected waves due to multipoint reflections can easily occur when a part of the body is covered with clothing or the like. Interference between reflected waves due to multipoint reflections is not limited to that occurring due to clothing but is also easily caused by objects with complex shapes, flexible objects, and the like. For these reasons, the conventional object detection method based on the mere frequency characteristics of the reflected waves has difficulty in detecting objects stably. The purpose of this disclosure is to provide an object detection device and an object detection method that can stably detect objects.

According to one aspect of the present disclosure, an object detection device includes: a transmitter that transmits a long pulse signal, in which a pulse width is longer than a predetermined time, as a transmission wave, the transmission wave being an ultrasonic wave, a receiver that obtains a received signal corresponding to a reflected wave reflected by an object of the transmission wave, a signal processor that obtains a fluctuation signal based on the received signal and detects the object based on the fluctuation signal. The fluctuation signal is a signal corresponding to a composite wave generated when receiving the reflected wave and a wave which frequency is different from the reflected wave, or a signal generated by a phase change of the reflected wave when the distance to the object changes.

Thus, by transmitting the long pulse signal with the long pulse width as the transmission wave, the sound pressure level of the transmission wave can be increased, and the signal/noise ratio of the received signal can be improved. This makes it possible to stably detect objects with low ultrasonic reflectivity or objects that are prone to interference between reflected waves due to multipoint reflections. In addition, when the transmission wave is the long pulse signal, the peak portion of the fluctuation is more likely to appear in the fluctuation signal than when the transmission wave is a short pulse signal. This greatly contributes to stable object detection.

According to another aspect of the present disclosure, an object detection method includes: transmitting a long pulse signal, in which a pulse width is longer than a predetermined time, as a transmission wave, the transmission wave being an ultrasonic wave, acquiring a received signal corresponding to a reflected wave reflected by an object of the transmission wave, obtaining a fluctuation signal based on the received signal, and detecting the object based on the fluctuation signal. The fluctuation signal is a signal corresponding to a composite wave generated when receiving the reflected wave and a wave which frequency is different from the reflected wave, or a signal generated by a phase change of the reflected wave when the distance to the object changes.

This enables stable detection of objects with low ultrasonic wave reflectivity and objects that are prone to interference between reflected waves due to multipoint reflections.

The parenthesized reference codes attached to each component, etc., indicate an example of the correspondence between the component, etc., and specific components, etc., described in embodiments to be described later.

The embodiments of the present disclosure are described below with reference to the drawings. In the following embodiments, parts that are the same or equivalent to the matters described in the preceding embodiments may be marked with the same reference symbols and their description may be omitted. In addition, when only a part of the components is described in the embodiments, the components described in the preceding embodiments may be applied to the other parts of the components. The following embodiments can be partially combined with each other, even when not specifically indicated, as long as the combination does not cause any particular obstacle.

### First Embodiment

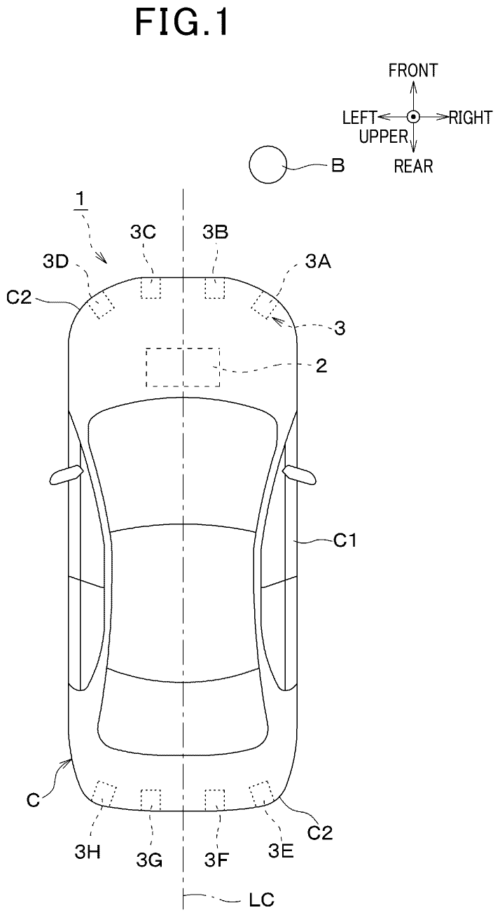

This embodiment is described with reference to FIGS. 1 through 15. This embodiment describes an example in which the object detection device of the present disclosure is applied to an in-vehicle system 1. In-vehicle system 1 is mounted to a vehicle C, which is a mobile vehicle, as shown in FIG. 1. The vehicle C is a so-called four-wheeled vehicle. The vehicle C includes a box-like body C1 formed in a substantially rectangular shape in plan view. The shape of each part of the vehicle C in plan view is the shape when each part of the vehicle C is viewed with a line of sight in the same direction as the direction of action of gravity, with the vehicle C stably placed on a horizontal surface so that it can be driven. The vehicle C equipped with the in-vehicle system 1 is hereinafter referred to as the “own vehicle”.

Hereinafter, the virtual straight line that passes through the center of the own vehicle in the vehicle width direction and is parallel to the vehicle length direction in the “own vehicle” is referred to as the vehicle center line LC in plan view. The vehicle length direction is orthogonal to the vehicle width direction and orthogonal to the vehicle height direction. The height direction is the direction that defines the height of the own vehicle. The height direction is parallel to the direction of action of gravity when the own vehicle is placed stably on a horizontal surface so that it can be driven. In addition, each of “front,” “rear,” “left,” “right,” and “upper” is defined as indicated by the arrows in FIG. 1. In other words, the overall vehicle length direction is synonymous with the front-back direction. The vehicle lateral direction is synonymous with the left-right direction.

The in-vehicle system 1 includes an electronic control device 2 and an ultrasonic sensor 3. The electronic control device 2 may be called ECU, which is in-vehicle microcomputer. The electronic control device 2 may include a CPU, ROM, RAM, nonvolatile rewritable memory, etc., not shown. ECU stands for Electronic Control Unit. The nonvolatile rewritable memory is a memory that can be rewritten while the power is on and holds information non rewritable while the power is off. Nonvolatile rewritable memory is, for example, flash ROM, etc. ROM, RAM and nonvolatile rewritable memory are non-transitory substantive storage media. The electronic control device 2 is mounted inside car body C1.

The electronic control device 2 communicates with the ultrasonic sensor3 via an in-vehicle communication link. The electronic control device 2 reads and executes a control program stored in ROM or nonvolatile rewritable memory to control an overall operation of the in-vehicle system 1. Controlling the overall operation of the in-vehicle system 1 includes controlling the timing of the transmission and reception of ultrasonic waves at each of the plurality of the ultrasonic sensors 3. The in-vehicle system 1 including the object detection device of this embodiment detects object B around the own vehicle based on the results of transmission and reception of ultrasonic waves by the ultrasonic sensors 3 in an in-vehicle state mounted to the own vehicle.

The front bumper, i.e., the bumper C2 on the front side in the vehicle body C1, in the own vehicle is equipped with a first front sensor 3A, a second front sensor 3B, a third front sensor 3C, and a fourth front sensor 3D, each of which is an ultrasonic sensor 3. The same is true for the rear bumper of the own vehicle. Similarly, the rear bumper of the own vehicle, i.e., the rear bumper C2 on the rear side of the vehicle body C1, is equipped with a first rear sensor 3E, a second rear sensor 3F, a third rear sensor 3G, and a fourth rear sensor 3H, each of which is an ultrasonic sensor3.

The first front sensor 3A is located at the right end in the front bumper. The first front sensor 3A transmits a transmission wave to the right front of the own vehicle. The second front sensor 3B is positioned between the first front sensor 3A and the vehicle centerline LC in the vehicle width direction. The second front sensor 3B transmits a transmission wave for short distance in front of the own vehicle. The third front sensor 3C is positioned symmetrically with the second front sensor 3B across the vehicle centerline LC. The third front sensor 3C is positioned between the vehicle centerline LC and the fourth front sensor 3D in the vehicle width direction. The third front sensor 3C transmits a transmission wave to the front of the vehicle. The fourth front sensor 3D is positioned symmetrically with the first front sensor 3A across the vehicle centerline LC. The fourth front sensor 3D is located at the left end of the front bumper. The fourth front sensor 3D transmits a transmission wave to the left front of the own vehicle.

The first rear sensor 3E is located at the right end in the rear bumper. The first rear sensor 3E transmits a transmission wave to the right rear of the own vehicle. The second rear sensor 3F is positioned between the first rear sensor 3E and the vehicle centerline LC in the vehicle width direction. The second rear sensor 3F transmits a transmission wave to the rear of the own vehicle. The third rear sensor 3G is positioned symmetrically with the second rear sensor 3F across the vehicle centerline LC. The third rear sensor 3G is positioned between the vehicle centerline LC and the fourth rear sensor 3H in the vehicle width direction. The third rear sensor 3G transmits a transmission wave to the rear of the own vehicle. The fourth rear sensor 3H is positioned symmetrically with the first rear sensor 3E across the vehicle centerline LC. The fourth rear sensor 3H is located at the left end of the rear bumper. The fourth rear sensor 3H transmits a transmission wave to the left rearward of the own vehicle.

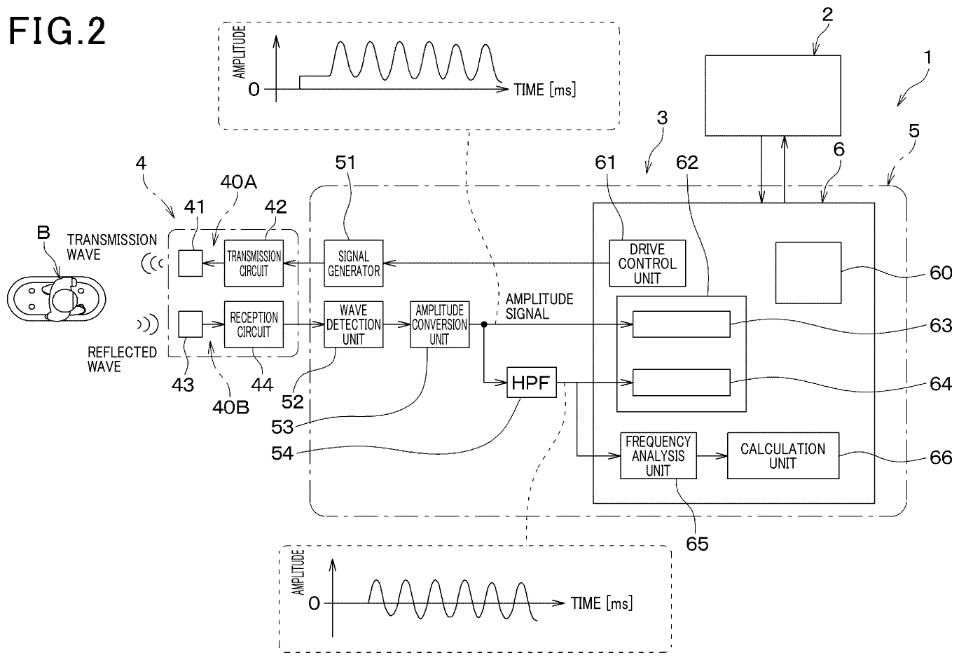

The schematic configuration of the ultrasonic sensor 3 is described with reference to FIG. 2. For the sake of simplicity, only one of the multiple ultrasonic sensors 3 connected to the electronic control device 2 is shown in FIG. 2, and the others are omitted.

The ultrasonic sensor3 is configured to transmit transmission waves, which are ultrasonic waves, toward the outside of the own vehicle. The ultrasonic sensor 3 detects the object B existing in the surroundings based on the received signal corresponding to the received wave including the reflected wave reflected by the object B, and obtains the distance to the object B, etc.

Specifically, ultrasonic sensor 3 includes transceiver 4 and signal processor 5. In this embodiment, the transceiver4 and signal processor5 are held by a single sensor housing made of synthetic resin or the like.

In this embodiment, ultrasonic sensor 3 has only one transceiver 4, and the transceiver 4 realizes the function of transmitting and receiving. The transceiver 4 functions as transmitter 40A, which transmits transmission waves to the outside, and as signal receiver 40B, which receives reception waves. One transceiver4 includes transmitter 40A and receiver 40B. The transmitter 40A and the receiver 40B may be integrally formed by a common transducer or may be formed separately.

Transmitter 40A has a speaker 41 and a transmission circuit 42. The speaker 41 transmits transmission waves, which are ultrasonic waves. The transmission circuit 42 causes speaker 41 to transmit transmission waves in the ultrasonic band by driving speaker 41 based on an input drive signal. The transmission circuit 42 has a digital/analog conversion circuit, etc. The transmission circuit 42 performs digital/analog conversion and other processing on the drive signal output by the signal processor 5. The transmission circuit 42 applies the AC voltage generated by this processing to the speaker 41.

The receiver 40B has a microphone 43 and a reception circuit 44. The microphone 43 receives ultrasonic waves including the reflected waves by the object B of transmission wave. The reception circuit 44 generates a received signal corresponding to the result of reception of ultrasonic waves by microphone 43. The reception circuit 44 has an amplification circuit and an analog/digital conversion circuit, etc. The reception circuit 44 amplifies the voltage signal input from the microphone 43 and converts it into a digital signal. By this operation, the reception circuit 44 generates and outputs the received signal according to the frequency, phase, and amplitude of the received ultrasonic wave.

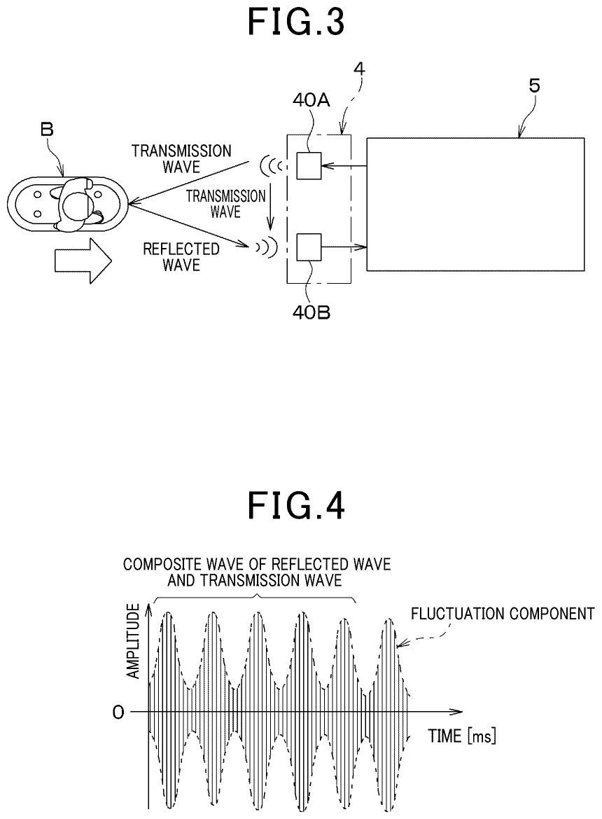

The receiver 40B in this embodiment, as shown in FIG. 3, is located at a position where it can directly receive the transmission wave transmitted by the transmitter 40A. For example, the microphone 43 of receiver 40B may be positioned adjacent to the speaker 41 of transmitter 40A. In this way, receiver 40B receives the composite wave of the transmission wave and the reflected wave as the receiving wave.

The signal processor 5 detects the object B based on the received signal obtained by receiver 40B. The signal processor 5 includes a signal generator 51, a wave detection unit 52, an amplitude conversion unit 53, a filter 54, and a sensor control unit 6.

The signal generator 51 generates a drive signal to the transmitter 40A. The drive signal is a signal to drive transmitter 40A to transmit transmission wave to speaker 41.

The wave detection unit 52 performs various signal processing such as orthogonal detection processing on the received signal output by the reception circuit 44. The wave detection unit52 outputs the processed signal, which is the result of various signal processing, to the amplitude conversion unit 53, etc.

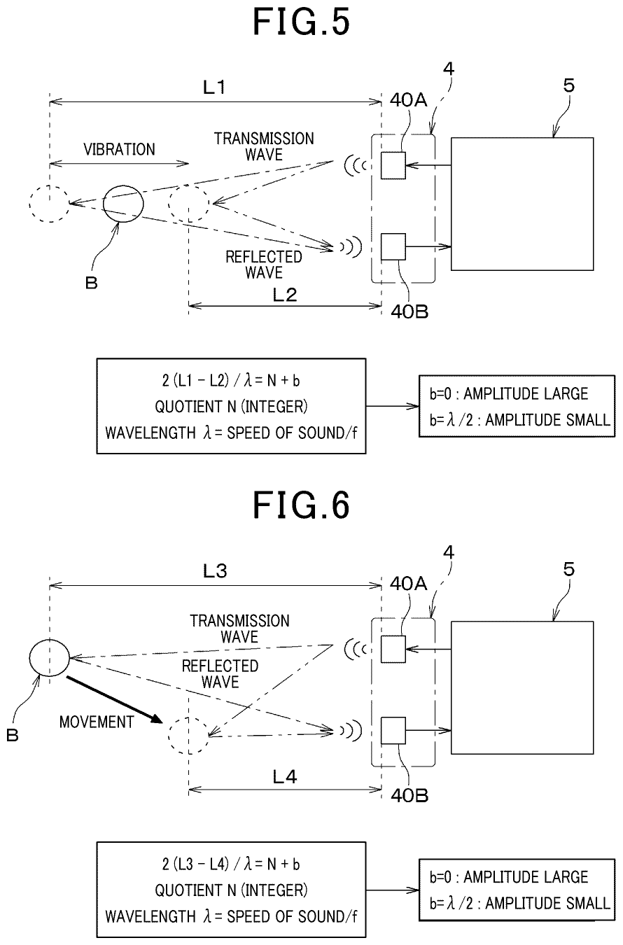

As mentioned above, the receiver 40B in this embodiment is located at a position where it can directly receive the transmission wave transmitted by transmitter 40A. Therefore, receiver 40B receives the composite wave of the transmission wave and the reflected wave. This composite wave contains the fluctuating “fluctuation component” shown in FIG. 4 due to the frequency difference of the reflected wave and the other wave (For example, the transmission wave) of which the frequency is different from the frequency of the reflected wave. On the other hand, the reflected wave undergoes a phase change when the distance from the object B changes. This causes an “fluctuation component” with fluctuation in the reflected wave. This “fluctuation component” changes according to the movement of the object B. For example, as shown in FIG. 5, when the object B moves due to vibration or shaking, the distance between object B and transceiver 4 changes from L1 to L2 or L2 to L1. This causes the amplitude of the “fluctuation component” to increase or decrease. As shown in FIG. 6, when the object B moves, the distance between the object B and the transceiver 4 changes from L3 to L4 or L4 to L3. This causes the amplitude of the “fluctuation component” to increase or decrease.

Thus, there is a correlation between the presence or absence or movement of the object B and the “fluctuation component”. The signal processor 5 obtains the “fluctuation signal” containing the “fluctuation component” based on the received signal and detects the object B based on the “fluctuation signal”. The signal processor 5 in this embodiment obtains the composite wave that occurs when the reflected wave and the other wave of which the frequency is different from the frequency of the reflected wave are received, or when the distance from the object B changes. In other words, the “fluctuation signal” is not only the signal corresponding to the fluctuation generated when waves of different frequencies are combined (so-called “fluctuation”), but the signal corresponding to fluctuations in the reflected wave caused by the phase change of the reflected wave when the distance from the object B changes.

The amplitude conversion unit 53 performs an envelope processing based on the signal obtained by processing in the wave detection unit 52. The amplitude conversion unit 53 may identify the envelope of the amplitude waveform as the “fluctuation component” as shown in the upper part of FIG. 2 and FIG. 4, for example. The amplitude conversion unit 53 outputs the “fluctuation signal” including the “fluctuation component” to sensor control unit 6, etc.

Filter 54 removes low-frequency components from an amplitude signal with a high-pass filter. Filter 54 may have a bandpass filter instead of a high-pass filter, as long as it can pass the band corresponding to the “fluctuation component.

The sensor control unit 6 communicates with the electronic control device 2. sensor control unit 6 controls the operation of the ultrasonic sensor 3 in cooperation with the electronic control device 2. The sensor control unit 6 controls the output of the drive signal from the signal generator 51 to the transmitter 40A, and also controls the “fluctuation signal” output by the amplitude conversion unit 53 and others. The sensor control unit 6 detects object B based on the “fluctuation signal” output by amplitude conversion unit 53, etc.

The sensor control unit 6 has a configuration as an in-vehicle microcomputer equipped with a CPU, ROM, RAM, nonvolatile rewritable memory, etc., not shown in the figure. The sensor control unit 6 is configured to read and execute a control program stored in the ROM or nonvolatile rewritable memory storage 60 to control the operation of the ultrasonic sensor 3. The memory 60 is a non-transitory substantive storage medium. Specifically, the sensor control unit 6 has a drive control unit 61, a detection unit 62, a frequency analysis unit 65, and a calculation unit 66.

The drive control unit 61 controls transmission state of the transmission wave from transmitter 40A by outputting the control signal to the signal generator 51. The control signal is a signal to control the output characteristics of the drive signal output from the signal generator 51 to the transceiver 4. Specifically, the output characteristics may include output timing and frequency, etc. The drive control unit 61 controls the output timing and frequency of the drive signals generated and output by the signal generator 51.

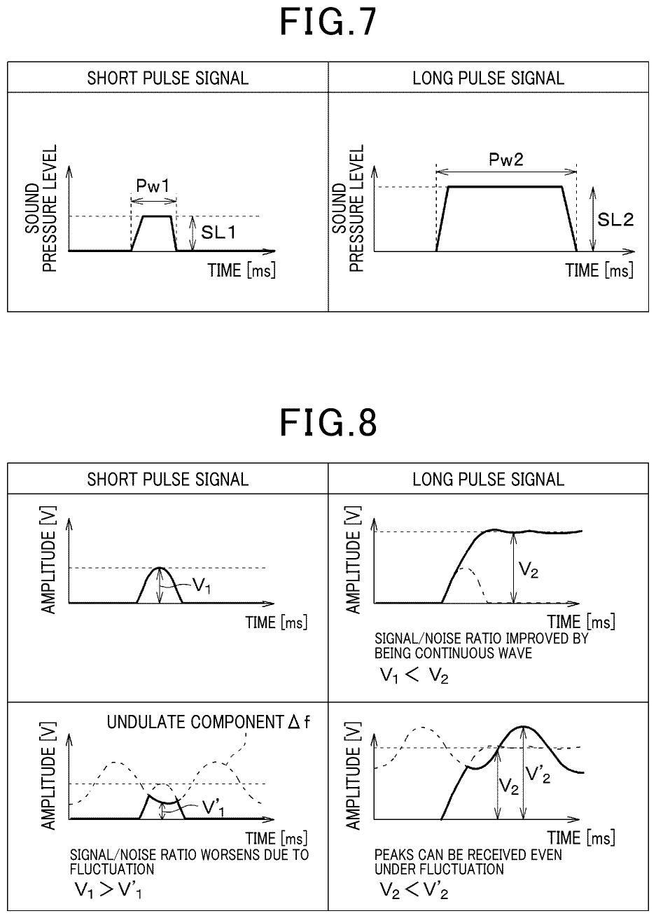

Generally, when measuring the distance to the object B using ultrasonic waves, a short pulse signal with a pulse width of less than a predetermined time is often transmitted as the transmission wave. However, as shown on the left side of FIG. 7, it is difficult to increase the sound pressure level SL1 of the short pulse signal because the pulse width Pw1 is small. The low sound pressure level SL1 is a factor that causes a decrease in the signal/noise ratio of the signal received by receiver 40B, as shown in the upper left part of FIG. 8.

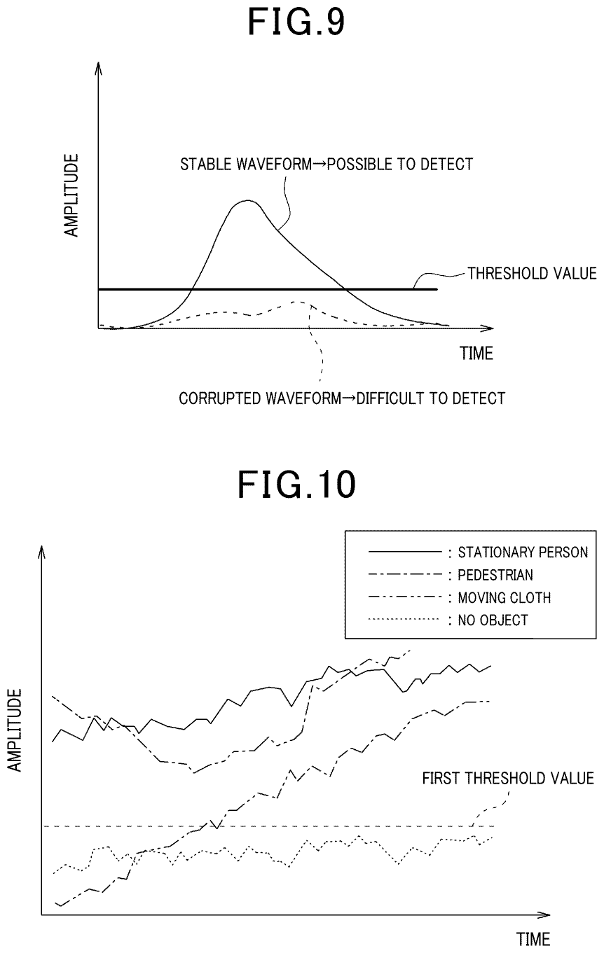

When the short pulse signal is transmitted as the transmission wave, the reflected wave of the transmission wave to the object B it is possible to detect the object B if the waveform is stable and the amplitude is large, as shown in FIG. 9. However, if the waveform is corrupted due to multiple reflections, etc., and the amplitude is small, it is difficult to detect the object B.

Furthermore, when the short pulse signal is transmitted as the transmission wave, as shown in the lower left part of FIG. 8, the amplitude waveform of the composite wave is corrupted by the “fluctuation component” and the amplitude becomes small. In this case, it is difficult to detect the object B.

In contrast, the long pulse signal, which has a pulse width longer than the predetermined time, has a longer pulse width Pw2 than the pulse width Pw1 of the short pulse signal, making it easier to increase the sound pressure level SL2, as shown in the right part of FIG. 7. In this case, the signal/noise ratio of the signal received by receiver 40B can be improved, as shown in the upper right part of FIG. 8.

In addition, when the long pulse signal is transmitted as the transmission wave, the reflected wave of the transmission wave to the object B has a larger amplitude due to the improved signal/noise ratio. Furthermore, when the long pulse signal is transmitted as the transmission wave, the composite wave of the transmission wave and the reflected wave is larger in amplitude even under the influence of the “fluctuation component”, as shown in the lower right part of FIG. 8.

As shown in FIG. 10, when the long pulse signal is transmitted as the transmission wave, using the composite wave of the transmission wave and the reflected wave and the first threshold value, it was found to be able to detect the object B. The object B is such as a stationary person, a pedestrian, a moving cloth, etc.

The drive control unit 61 outputs the control signal to the signal generator 51 so that the long pulse signal with a pulse width longer than the predetermined time is transmitted as the transmission wave. The transmission interval of the long pulse signal is not limited to a fixed interval but can be an indefinite interval.

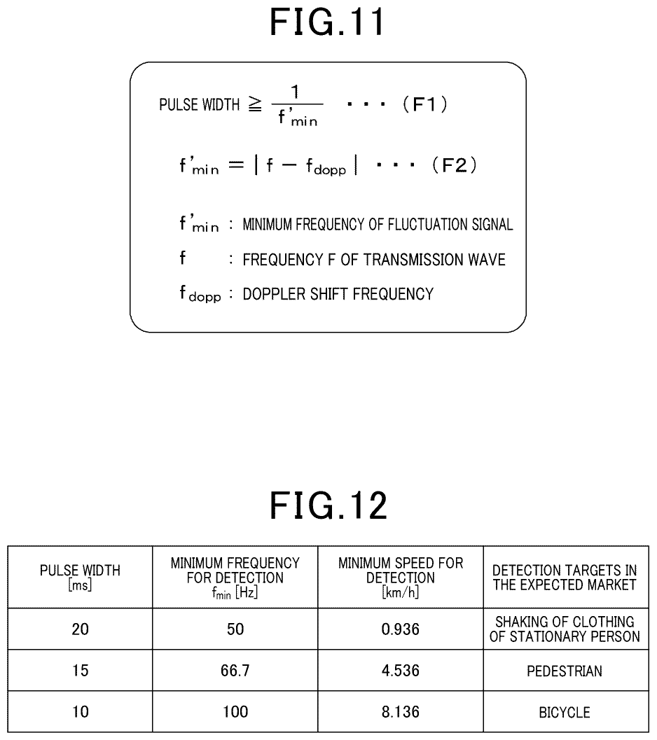

The pulse width of the long pulse signal is set so that the peaks of the amplitude waveform of the composite wave can be received. Specifically, the pulse width of the long pulse signal is set to a time longer than the minimum cycle assumed in advance as the cycle of the “fluctuation signal,” as shown in Formula F1 in FIG. 11. The period of the “fluctuation signal” is the reciprocal of the minimum frequency f′min of the frequency of the “fluctuation signal”. The minimum frequency f′min of the “fluctuation signal” frequency is calculated based on the frequency f of the transmission wave and the Doppler shift frequency fdopp, which is generated by the speed difference between the vehicle C and the object B.

According to the trial calculation of the inventors of this application, as shown in FIG. 12, it was found that a bicycle traveling at about 8 km/h can be detected when the pulse width of the long pulse signal is 10 ms, and a pedestrian walking at about 4 km/h can be detected when the pulse width of the long pulse signal is 15 ms. Furthermore, when the pulse width of the long pulse signal is set to 20 ms, it was found to be able to detect the shaking of clothing of a stationary person.

Considering the safety of people in the vicinity of the vehicle C, it is desirable to be able to detect the shaking of a stationary person's clothing. Therefore, the pulse width of the long pulse signal should be set to 20 ms or longer.

The detection unit 62 determines the presence or absence of the object B and the movement of the object B based on the “fluctuation signal” obtained by the amplitude conversion unit 53. The movement of the object B includes movement and slight movement of the object B. The detection unit 62 has a first determination unit 63 and a second determination unit 64.

The first determination unit 63 determines the presence or absence of the object B based on the “fluctuation signal”. For example, as shown in FIG. 10, the first determination unit 63 determines the object B is present when the amplitude waveform of the “fluctuation signal” has a portion that exceeds the first threshold value and determines the object B is absent when there is no portion that exceeds the first threshold value. The first threshold value is set to an appropriate value based on experiments or simulations.

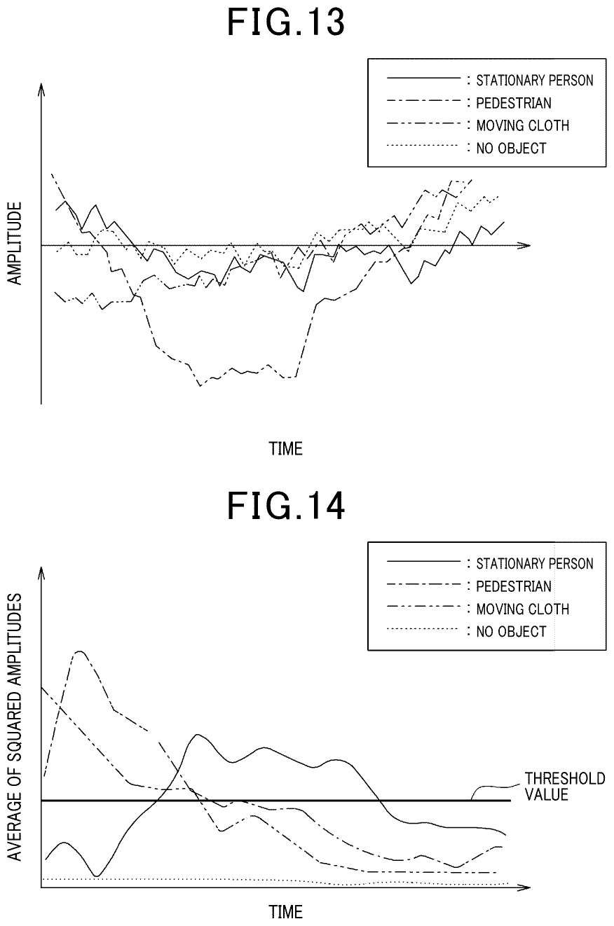

The second determination unit 64 determines the movement of the object B, including vibration, slight movement, movement, etc., based on the signal for which the bandwidth of the “fluctuation signal” is limited by the filter 54. The determination unit 64 obtains the signal component corresponding to the motion of the object B as shown in FIG. 13, which is extracted by limiting the bandwidth of the “fluctuation signal” by the filter 54. Next, the second determination unit 64 obtains the signal component that is the average of the squared amplitudes of the signal components that passed through filter 54. Next, the second determination unit 64 determines, as shown in FIG. 14, that the object B has motion when there is a portion of the signal amplitude waveform that exceeds the second threshold value and determines that the object B has no motion when there is no portion that exceeds the second threshold value. Since the amplitude of the signal may fluctuate in the negative direction due to the movement of the object B, the signal obtained by averaging the squared amplitude of the signal components that have passed through filter 54 is used to determine the movement of object B.

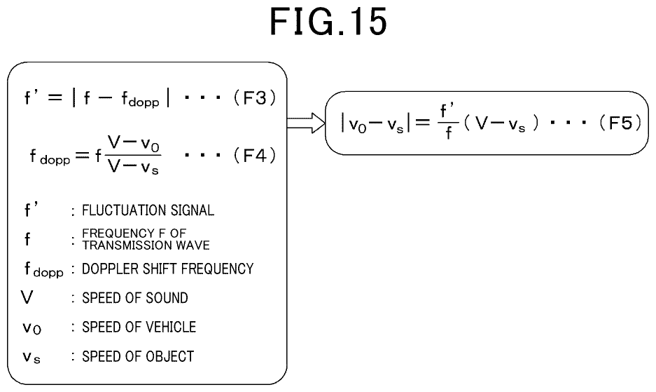

The frequency analysis unit 65 obtains the Doppler shift frequency based on the “fluctuation signal. The Doppler shift frequency occurs due to the relative speed of the receiver 40B and the object B. For example, the frequency analysis unit 65 may obtain the frequency of the signal for which the bandwidth of the “fluctuation signal” is limited by the filter 54 as “fluctuation frequency f′” and input the “fluctuation frequency f′” and the frequency f of the transmission wave into the formula F3 in FIG. 15 to calculate the Doppler shift frequency fdopp.

The calculation unit 66 calculates the speed vs of the object B based on the Doppler shift frequency fdopp. As shown in formulas F4 and F5 in FIG. 15, there is a correlation between the speed vs of the object B and the Doppler shift frequency fdopp. The calculation unit 66 in this embodiment obtains the speed vs of the object B from the Doppler shift frequency fdopp using a learned model such as a neural network. Alternatively, the calculation unit 66 may obtain the speed vs of the object B by inputting the speed of sound V, the speed v0 of vehicle C, the frequency f of the transmission wave, and the Doppler shift frequency fdopp into formulas F4, F5, etc.

Next, explanations of the object detection process and the object detection method by the in-vehicle system 1 are given. When a predetermined object detection condition is satisfied, the electronic control device 2 causes the ultrasonic sensor 3 to repeatedly execute the detection process of the object B in a predetermined cycle.

When receiving a command signal from the electronic control device 2, the ultrasonic sensor 3 repeatedly executes the detection process of the object B in the predetermined cycle.

Specifically, the sensor control unit 6 outputs the control signal to the signal generator 51, the control signal being a signal instructing to transmit the long pulse signal. The signal generator 51 generates the drive signal based on the control signal and outputs the generated drive signal to the transmitter 40A. As a result, transmitter 40A is driven and the transmission wave is transmitted externally from the own vehicle.

When the reflected wave generated by the transmission wave being reflected by the object B and the transmission wave transmitted from transmitter 40A reach the receiver 40B, the receiver 40B receives the composite wave of the reflected wave and the transmission wave. The receiver 40 performs signal processing such as the amplification and the analog/digital conversion on the voltage signal corresponding to the composite wave and generates the received signal. The receiver 40B outputs the received signal to the wave detection unit 52.

The wave detection unit 52 performs various signal processing on the received signal to generate a process signal including the amplitude signal and outputs it to the amplitude conversion unit 53. The wave detection unit 52, for example, generates a phase signal and the amplitude signal by an orthogonal wave processing and outputs the generated signals to the amplitude conversion unit 53. The amplitude conversion unit 53 obtains the “fluctuation signal” corresponding to the amplitude change of the received signal based on the signals obtained by the wave detection unit 52 and outputs the “fluctuation signal” to the sensor control unit 6, etc.

The sensor control unit 6 detects the object B based on the “fluctuation signal” output by the amplitude conversion unit 53, etc. The sensor control unit 6 may detect not only the presence or absence of the object B, but also the movement of the object B and the speed of the object B based on the “fluctuation signal”.

The in-vehicle system 1 described above has the transmitter 40A that transmits the long pulse signal as the transmission wave, the receiver 40B that obtains the received signal corresponding to the reflected wave, and the signal processor 5 that detects the object B based on the “fluctuation signal” corresponding to the amplitude change of the composite wave of the transmission wave and the reflected wave or the phase change of the reflected wave when the distance from the object B changes. By transmitting the long pulse signal with the long pulse width as the transmission wave, the sound pressure level of the transmission wave can be increased, and the signal/noise ratio of the received signal can be improved. Therefore, in-vehicle system 1 can stably detect the object B, even one which has low ultrasonic wave reflectivity and is prone to interference between reflected waves due to multipoint reflections. In addition, by transmitting the long pulse signal with the long pulse width as the transmission wave, the peak portion of “fluctuation” appears in the “fluctuation signal” compared to when the transmission wave is the short pulse signal. This greatly contributes to the stable detection of the object B.

The in-vehicle system 1 in this embodiment has the following features.

(1) The pulse width of the long pulse signal is set to a time longer than the minimum cycle assumed in advance as the cycle of the “fluctuation signal. When the long pulse signal with this pulse width is used as the transmission wave, the peak portion of the “fluctuation signal” easily appears in the “fluctuation signal”. As a result, the detection of the object B by the in-vehicle system 1 can be stabilized.

(2) The receiver 40B is positioned to directly receive the transmission wave transmitted from transmitter 40A. According to this, the composite wave of the transmission wave and the reflected wave can be obtained without using the adder 55 or mixer 56 described below. As a result, the “fluctuation signal” can be obtained with a simple configuration.

(3) The signal processor 5 calculates the Doppler shift frequency fdopp generated by the relative speed with the object B based on the “fluctuation signal. The Doppler shift frequency fdopp has a correlation with the relative speed between receiver 40B and the object B. Therefore, by calculating the Doppler shift frequency fdopp, it is possible to obtain the relative speed between the receiver 40B and the object B. Especially, when the speed of object B can be obtained, as in this embodiment, it becomes easier to identify whether the detected object B corresponds to a stationary person, a pedestrian, or a bicycle, etc.

(4) The signal processor 5 determines the motion of object B, such as the vibration, the slight movement, or the movement, based on the “fluctuation signal”. By detecting not only the presence or absence of the object B but also its movement, it becomes easier to identify whether the detected object B corresponds to the person, an animal or other living thing, or an installation such as a wall.

### Variation of the First Embodiment

The pulse width of the long pulse signal should be set to a time longer than the minimum cycle assumed in advance as the cycle of the “fluctuation signal,” but it is not limited to this. For example, the pulse width of the long pulse signal may be set to be longer than or equal to the Doppler shift frequency fdopp period assumed in advance.

It is desirable for the signal processor 5 to be able to detect the movement of the object B and the speed of the object B as well as to determine the presence or absence of the object B. However, it is not limited to. For example, the signal processor 5 may determine the presence or absence of the object B and may not detect the movement of the object B or the speed of the object B.

### Second Embodiment

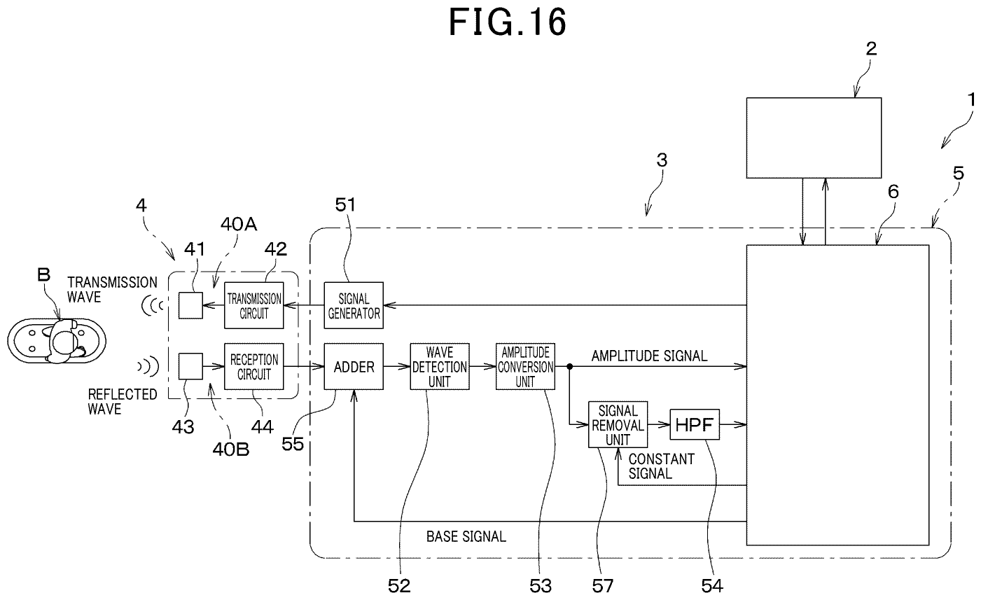

Next, a second embodiment is described with reference to FIGS. 16 through 18. In this embodiment, the parts that differ from the first embodiment are mainly explained.

The signal processor 5 of this embodiment is configured to obtain the composite wave of the transmission wave and the reflected wave reflected by adding a base signal based on the frequency of the transmission wave to the received signal. Specifically, the signal processor 5 is configured as shown in FIG. 16. Specifically, as shown in FIG. 16, signal processor 5 has an adder 55 between the reception circuit 44 and the wave detection unit 52. The adder 55 adds the base signal generated by the sensor control unit 6 to the received signal generated by the reception circuit 44 to generate the composite wave of transmission wave and reflected wave. The adder 55 outputs the composite wave of the transmission wave and the reflected wave to amplitude conversion unit 53 via a bandpass filter or the like. The base signal is a digital signal with the same frequency as the frequency of the transmission wave.

In the signal processor 5, the adder 55 may be provided between the microphone 43 and the reception circuit 44, and the base signal may be added by the adder 55 to the analog signal received by the microphone 43 to generate the composite wave of the transmission wave and the reflected wave. In this case, the base signal may be an analog signal of the same frequency as the frequency of the transmission wave.

The signal processor 5 is provided with a distance measurement unit 67 that measures the distance to the object B based on the “fluctuation signal” output by the amplitude conversion unit 53 and others. For example, the distance measurement unit 67 may calculate the distance to the object B based on the reception time when an “fluctuation signal” exceeding a predetermined threshold value is detected.

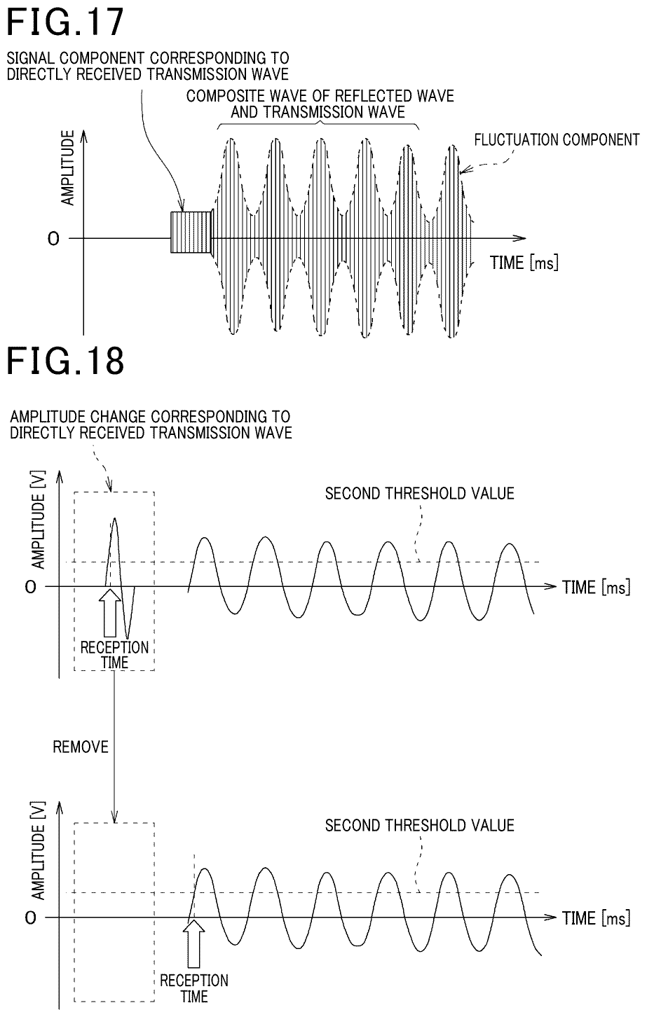

Transmission waves may be directly received by the receiver 40B before the reflected wave reaches the receiver 40B. In this case, the received signal at the receiver 40B includes a signal component corresponding to the directly received transmission wave, as shown in FIG. 17. When such a signal component is included, as shown in the upper part of FIG. 18, the “fluctuation signal” output by the amplitude conversion unit 53 shows an amplitude change corresponding to the directly received transmission wave. Such amplitude changes adversely affect the calculation of the distance to the object B in the distance measurement unit 67.

In the signal processor 5, the constant signal, that is stored in memory 60 as a constant signal, is a signal corresponding to the received signal obtained by the receiver 40B when the object B is not detected. signal. The signal processor 5 detects the object B based on the signal obtained by removing the constant signal from the “fluctuation signal”. The constant signal is the signal corresponding to the amplitude change corresponding to the transmission wave directly received in the “fluctuation signal” output by unit 53. The constant signal may be obtained by processing the received signal obtained by the receiver 40B when the object B is not detected by the amplitude conversion unit 53.

In the signal processor 5, between amplitude conversion unit 53 and filter 54, a signal removal unit 57 that removes the constant signal from the “fluctuation signal” is provided. The signal output by the signal removal unit 57 removes the signal component corresponding to the transmission wave that is directly received, as shown in the lower part of FIG. 18.

Other details are the same as in the first embodiment. The in-vehicle system 1 of this embodiment can obtain the same effects as the first embodiment that can be achieved from a common or equal configuration to the first embodiment.

The in-vehicle system 1 of this embodiment has the following features.

(1) The signal processor 5 is configured to obtain the composite wave by adding the base signal based on the frequency of the transmission wave to the received signal. According to this, the “fluctuation signal” can be obtained by a simple operation using the adder 55. In addition, since the transmitter 40A and the receiver 40B do not need to be placed next to each other, it is easier to secure a degree of freedom of layout inside ultrasonic sensor 3.

(2) Signal processor 5 stores the signal corresponding to the received signal obtained by the receiver 40B while the object B is not detected in the memory 60 as the constant signal. The object B is detected based on the signal obtained by removing the constant signal from the “fluctuation signal”. According to this method, the influence of the transmission wave directly received by the receiver 40B on the detection of the object B can be suppressed.

In particular, the signal processor 5 of this embodiment measures the distance to the object B. The signal processor 5 is equipped with the signal removal unit 57 to suppress the influence on the measurement of the distance to the object B by the transmission wave directly received by the receiver 40B.

### Third Embodiment

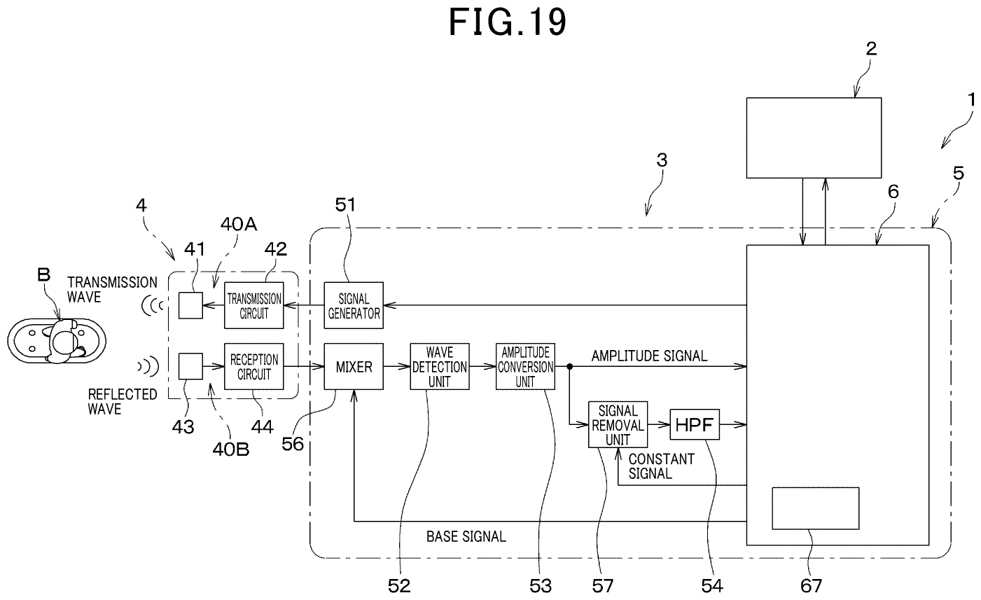

Next, a third embodiment is described with reference to FIG. 19. The third embodiment is described with reference to FIG. 19. In this embodiment, the parts that differ from the second embodiment are mainly explained.

The signal processor 5 of this embodiment is configured to obtain the composite wave of the transmission wave and the reflected wave reflected by heterodyne detection using the base signal based on the frequencies of the received signal and the transmission wave. As shown in FIG. 19, in the signal processor 5, a mixer 56 is provided between the reference circuit 44 and the wave detection unit 52. The mixer 56 generates the composite wave of the transmission wave and the reflected wave reflected by integrating the base signal generated by the sensor control unit 6 with the received signal generated by the reception circuit 44. The mixer 56 outputs the composite wave of transmission wave and the reflected wave to the amplitude conversion unit 53 via a low-pass filter and the like.

Other details are the same as in the second embodiment. The in-vehicle system 1 of this embodiment can obtain the same effects as the second embodiment that can be achieved from a common or equal configuration to the second embodiment.

The in-vehicle system 1 of this embodiment has the following features.

(1) The signal processor 5 is configured to obtain the composite wave of the transmission wave and the reflected wave reflected by heterodyne detection using the base signal based on the frequencies of the received signal and the transmission wave. According to this configuration, the “fluctuation signal” can be obtained by a simple operation using the mixer 56.

### Fourth Embodiment

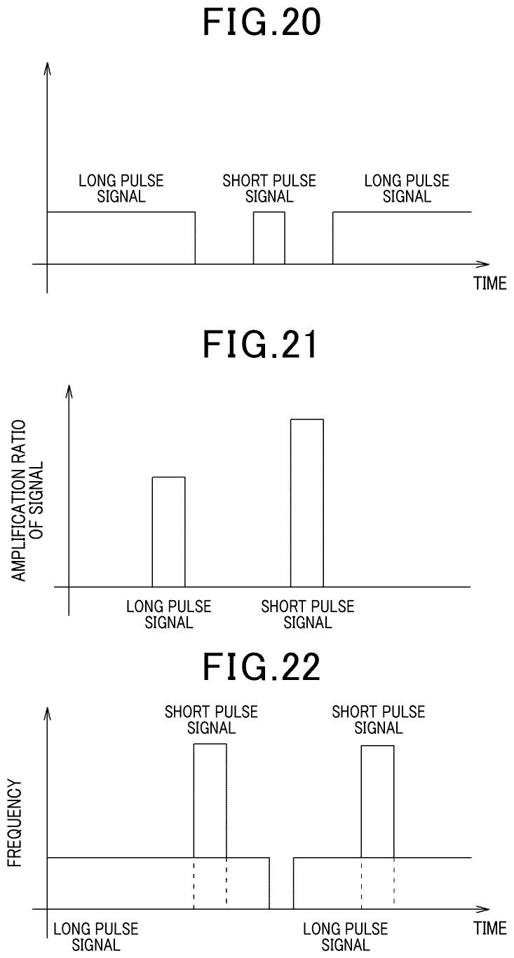

Next, a fourth embodiment is described with reference to FIGS. 20 and 21. In this embodiment, the parts that differ from the first embodiment are mainly explained.

When a long pulse signal is transmitted as the transmission wave, if the distance to the object B is short, it is difficult for the receiver 40B to distinguish between the transmission wave directly received by receiver 40B and the reflected wave, and the measurement accuracy of the distance to the object B tends to be lowered.

Therefore, the drive control unit 61 of signal processor 5 transmits a long pulse signal and a short pulse signal, which a pulse width of the short pulse signal being less than the predetermined time as a transmission wave. The drive control unit 61 of this embodiment switches the long pulse signal and the short pulse signal in time and transmits them as the transmission wave from the transmitter 40A. As shown in FIG. 20, the long pulse signal and short pulse signal may be alternately transmitted from the transmitter 40A as the transmission wave.

In the in-vehicle system 1 of this embodiment, for example, as shown in FIG. 21, the amplification ratio of the long pulse signal in the receiver 40B is smaller than that of the short pulse signal. Specifically, in the receiver 40B, the amplification circuit of the reception circuit 44 makes the amplification ratio of the signal when the long pulse signal is transmitted as the transmission signal and the reflected wave reflected by the object B is received smaller than the amplification ratio of the signal when the short pulse signal is transmitted as the transmission signal and the reflected wave reflected by the object B is received.

Other details are the same as in the first embodiment. The in-vehicle system 1 of this embodiment can obtain the same effects as the first embodiment that can be achieved from a common or equal configuration to the first embodiment.

The in-vehicle system 1 of this embodiment has the following features.

(1) The signal processor 5 includes the drive control unit 61 that controls the transmitter 40A. The drive control unit 61 transmits the long pulse signals and the short pulse signals as the transmission waves. When the short pulse signal is transmitted as the transmission wave, it is easier to ensure the measurement accuracy of the distance to the object B than when the long pulse signal is transmitted as the transmission wave. For this reason, the drive control unit 61 can transmit not only the long pulse signal but also the short pulse signal as the transmission wave from transmitter 40A.

(2) The drive control unit 61 switches the long pulse signal and the short pulse signal in time and transmits them as the transmission wave from transmitter 40A. Thus, if the long pulse signal and short pulse signal are switched in time, the detection of the object B can be stabilized while ensuring the accuracy of distance measurement to the object B.

(3) In the in-vehicle system 1, the amplification ratio of the long pulse signal in receiver 40B is smaller than that of the short pulse signal. This makes it possible to stabilize the detection of the object B and reduce power consumption associated with the increase in pulse width of the transmission wave.

### Fifth Embodiment

Next, a fifth embodiment is explained with reference to FIG. 22. In this embodiment, the parts that differ from the fourth embodiment are mainly explained.

When the long pulse signal and the short pulse signal are switched in time, as in the fourth embodiment, the detection of the object B and the measurement of the distance to the object B are carried out at different times, and the time required for the object detection process becomes longer.

The drive control unit 61 of this embodiment makes frequencies of the long pulse signal and the short pulse signal different, and transmits the long pulse signal and the short pulse signal simultaneously as the transmission wave from the transmitter 40A. For example, as shown in FIG. 22, the drive control unit 61 simultaneously transmits the long pulse signal and short pulse signal with different frequencies as the transmission wave from the transmitter 40A. The frequencies of the long pulse signal and the short pulse signal are set so that the difference in their respective frequencies is greater than the bandwidth of the bandpass filter so that they can be separated by the bandpass filter.

Other details are the same as in the fourth embodiment. The in-vehicle system 1 of this embodiment can obtain the same effects as the fourth embodiment that can be achieved from a common or equal configuration to the fourth embodiment.

The in-vehicle system 1 of this embodiment has the following features.

(1) The drive control unit 61 transmits the long pulse signal and the short pulse signal with different frequencies from the transmitter 40A. This allows detection of object B and measurement of the distance to the object B to be performed at the same time, thus it is possible to shorten the time required for the object detection process.

### Sixth Embodiment

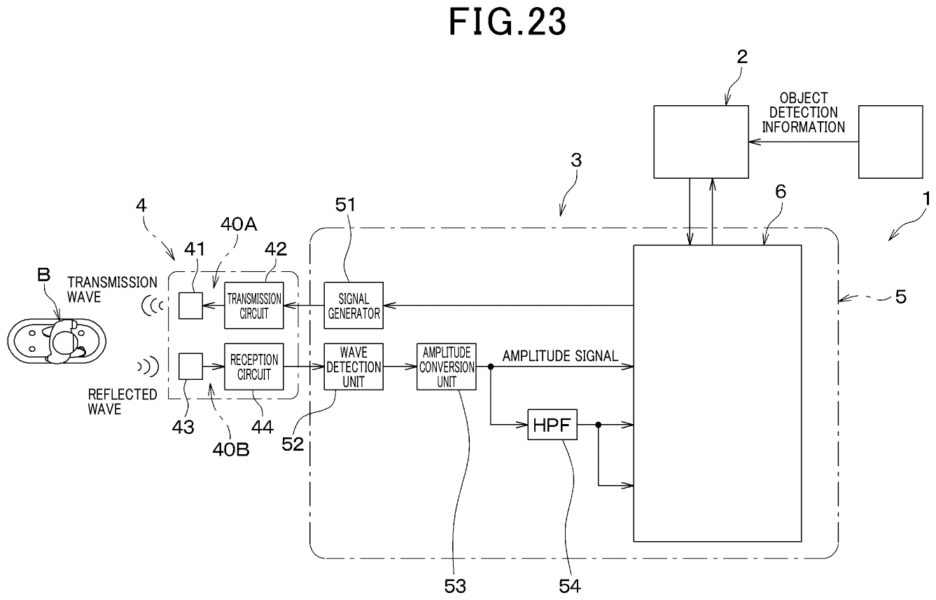

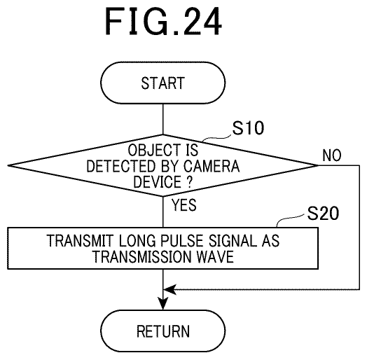

Next, a sixth embodiment is explained with reference to FIGS. 23 and 24. In this embodiment, the parts that differ from the first embodiment are mainly explained.

As shown in FIG. 23, the electronic control device 2 of the in-vehicle system 1 communicates with a camera device CD, one of the monitoring devices that monitor the surroundings of the vehicle C, via the in-vehicle communication link, and obtains the detection result of the object B by the camera device CD as object detection information from camera device CD. In this embodiment, the camera device CD corresponds to the “other devices”.

The signal processor 5 of the ultrasonic sensor 3 obtains the object detection information from the camera device CD via the electronic control device 2. The drive control unit 61 in the signal processor 5 transmits the long pulse signal as the transmission wave when the object B is detected by the camera device CD.

As shown in FIG. 24, the drive control unit 61 determines in step S10 whether the object B is detected by the camera device CD. The determination process in step S10 is performed, for example, based on the object detection information obtained from the camera device CD.

When the object B is detected by the camera device CD, the drive control unit 61 transmits the long pulse signal as the transmission wave from the transmitter 40A in step S20. Then, the sensor control unit 6 performs various processes including determining the presence or absence of the object B and its movement.

On the other hand, when the object B is not detected by the camera device CD, the drive control unit 61 skips processing in step S20. When the object B is not detected by the camera device CD, the drive control unit 61 may transmit the short pulse signal as the transmission wave from transmitter 40A.

Other details are the same as in the first embodiment. The in-vehicle system 1 of this embodiment can obtain the same effects as the first embodiment that can be achieved from a common or equal configuration to the first embodiment.

The in-vehicle system 1 of this embodiment has the following features.

(1) The drive control unit 61 transmits the long pulse signal as the transmission wave when the object B is detected by the camera device CD. Frequent transmission of the long pulse signals causes an increase of power consumption and reduced durability of in-vehicle systems 1. Therefore, it is desirable to transmit the long pulse signal as the transmission wave when the object B is detected by the camera device CD

### Variation of the Sixth Embodiment

The in-vehicle system 1 of the sixth embodiment may transmit the long pulse signal as the transmission wave when the object B is detected by a device other than the camera device CD. Also, in-vehicle system 1 may transmit at least one of the long pulse signal and the short pulse signal as the transmission wave when the object B is detected by other devices.

### Other Embodiments

The above is a description of representative embodiments of the present disclosure.

In the embodiments described above, the specific configuration of the object detection device of the present disclosure was shown. However, the object detection device of the present disclosure is not limited to the configuration described above and may differ in some parts.

In the embodiment described above, the signal processor 5 of the ultrasonic sensor 3 operates the object detection process. Instead of this, for example, the electronic control device 2 may also operate the object detection process. Also, the ultrasonic sensor 3 and the electronic control device 2 may perform the object detection process cooperatively.

Each of the functional configuration blocks shown in FIG. 2, etc., is a functional configuration block set up for convenience in order to contribute to an understanding of the contents of the object detection device of the present disclosure, and may not actually be distinguishable as software or hardware.

In the embodiments described above, the object detection device of the present disclosure is applied to the in-vehicle system 1, but the object detection device can also be applied to systems other than the in-vehicle system 1.

It goes without saying that, in the embodiments described above, the elements constituting the embodiments are not necessarily essential, except in cases where it is explicitly stated that they are particularly essential, or where they are clearly considered essential in principle, etc.

In the above-mentioned embodiments, when numerical values of the number, numerical value, amount, range, etc. of the components of an embodiment are mentioned, they are not necessarily limited to that specific number, except in cases where they are expressly stated to be particularly essential and in cases where they are clearly limited to a specific number in principle, etc.

In the above embodiments, when reference is made to the shape, positional relationship, etc. of the components, etc., the shape, positional relationship, etc. is not limited to such shape, positional relationship, etc., except when expressly stated otherwise or when limited to a specific shape, positional relationship, etc. in principle.

The control section of the present disclosure and its method may be realized in a dedicated computer provided by configuring a processor and memory programmed to perform one or more functions embodied by a computer program. The control section of the present disclosure and its methods may be realized in a dedicated computer provided by configuring the processor with one or more dedicated hardware logic circuits. The control section of the present disclosure and its methods may be realized in one or more dedicated computers provided by a combination of a processor and memory programmed to perform one or more functions and a processor configured by one or more dedicated hardware logic circuits. The computer program may also be stored in a computer-readable non-transitory recording medium as instructions to be executed by the computer.

### Aspects of the Present Disclosure

The present disclosure provides the following aspects.

### [First Aspect]

An object detection device, comprising:
a transmitter (40A) that transmits a long pulse signal, in which a pulse width is longer than a predetermined time, as a transmission wave, the transmission wave being an ultrasonic wave;
a receiver (40B) that obtains a received signal corresponding to a reflected wave reflected by an object (B) of the transmission wave;
a signal processor (5) that obtains a fluctuation signal based on the received signal and detects the object based on the fluctuation signal, wherein
the fluctuation signal is a signal corresponding to a composite wave generated when receiving the reflected wave and a wave which frequency is different from the reflected wave, or a signal generated by a phase change of the reflected wave when the distance to the object changes.

### [Second Aspect]

The object detection device according to the first aspect, wherein
the pulse width of the long pulse signal is set to a time longer than the minimum cycle assumed in advance as the cycle of the fluctuation signal.

### [Third Aspect]

The object detection device according to the first aspect or the second aspect, wherein
the signal processor is configured to obtain the composite wave by adding a base signal based on a frequency of the transmission wave to the received signal.

### [Fourth Aspect]

The object detection device according to the first aspect or the second aspect, wherein
the signal processor is configured to obtain the composite wave by heterodyne detection using a base signal based on the received signal and a frequency of the transmission wave.

### [Fifth Aspect]

The object detection device according to the first aspect or the second aspect, wherein
the receiver is positioned to directly receive the transmission wave transmitted from the transmitter.

### [Sixth Aspect]

The object detection device according to the first aspect, wherein
the signal processor obtains a Doppler shift frequency generated by the relative speed between the object and the object detection device based on the fluctuation signal.

### [Seventh Aspect]

The object detection device of according to the third aspect or the fourth aspect, wherein
the signal processor stores a signal corresponding to the received signal obtained by the receiver in a state where the object is not detected in the memory (60) as a constant signal, and detects the object based on a signal obtained by removing the constant signal from the fluctuation signal.

### [Eighth Aspect]

The object detection device according to any one of the first aspect to the seventh aspect, wherein
the signal processor includes a drive control unit (61) that controls the transmitter,
the drive control unit transmits as the transmission wave a long pulse signal and a short pulse signal in which pulse width is less than the predetermined time.

### [Ninth Aspect]

The object detection device according to the eighth aspect, wherein

The drive control unit has the transmitter transmit the long pulse signal and the short pulse signal alternately as the transmission wave.

### [Tenth Aspect]

The object detection device according to the eighth aspect or the ninth aspect, wherein

The drive control unit has the transmitter transmit the long pulse signal and the short pulse signal at different frequencies simultaneously.

### [Eleventh Aspect]

The object detection device according to any one of the eighth aspect to the tenth aspect, wherein
an amplification ratio of the long pulse signal at the receiver is smaller than the amplification ratio of the short pulse signal at the receiver.

### [Twelfth Aspect]

The object detection device according to any one of the first aspect to the eleventh aspect, wherein
the signal processor includes a drive control unit (61) that controls the transmitter,
the drive control unit has the transmitter transmit the long pulse signal as the transmission wave when the object is detected by other equipment.

### [Thirteenth Aspect]

An object detection method, comprising:
transmitting a long pulse signal, in which a pulse width is longer than a predetermined time, as a transmission wave, the transmission wave being an ultrasonic wave;
acquiring a received signal corresponding to a reflected wave reflected by an object (B) of the transmission wave;
obtaining a fluctuation signal based on the received signal; and
detecting the object based on the fluctuation signal, wherein
the fluctuation signal is a signal corresponding to a composite wave generated when receiving the reflected wave and a wave which frequency is different from the reflected wave, or a signal generated by a phase change of the reflected wave when the distance to the object changes.

What is claimed is:

1. An object detection device, comprising:
a transmitter that transmits a long pulse signal, in which a pulse width is longer than a predetermined time, as a transmission wave, the transmission wave being an ultrasonic wave;
a receiver that obtains a received signal corresponding to a reflected wave reflected by an object of the transmission wave;
a signal processor that obtains a fluctuation signal based on the received signal and detects the object based on the fluctuation signal, wherein
the fluctuation signal is a signal corresponding to a composite wave generated when receiving the reflected wave and a wave which frequency is different from the reflected wave, or a signal generated by a phase change of the reflected wave when the distance to the object changes.

2. The object detection device according to claim 1, wherein
the pulse width of the long pulse signal is set to a time longer than the minimum cycle assumed in advance as the cycle of the fluctuation signal.

3. The object detection device according to claim 1, wherein
the signal processor is configured to obtain the composite wave by adding a base signal based on a frequency of the transmission wave to the received signal.

4. The object detection device according to claim 1, wherein
the signal processor is configured to obtain the composite wave by heterodyne detection using a base signal based on the received signal and a frequency of the transmission wave.

5. The object detection device according to claim 1, wherein,
the receiver is positioned to directly receive the transmission wave transmitted from the transmitter.

6. The object detection device according to claim 1, wherein
the signal processor obtains a Doppler shift frequency generated by the relative speed between the object and the object detection device based on the fluctuation signal.

7. The object detection device of according to 3, wherein
the signal processor stores a signal corresponding to the received signal obtained by the receiver in a state where the object is not detected in the memory as a constant signal, and detects the object based on a signal obtained by removing the constant signal from the fluctuation signal.

8. The object detection device according to claim 1, wherein
the signal processor includes a drive control unit that controls the transmitter,
the drive control unit transmits as the transmission wave a long pulse signal and a short pulse signal in which pulse width is less than the predetermined time.

9. The object detection device according to claim 8, wherein
The drive control unit has the transmitter transmit the long pulse signal and the short pulse signal alternately as the transmission wave.

10. The object detection device of according to claim 8, wherein
The drive control unit has the transmitter transmit the long pulse signal and the short pulse signal at different frequencies simultaneously.

11. The object detection device of claim 8, wherein
an amplification ratio of the long pulse signal at the receiver is smaller than the amplification ratio of the short pulse signal at the receiver.

12. The object detection device according to claim 1, wherein
the signal processor includes a drive control unit that controls the transmitter,
the drive control unit has the transmitter transmit the long pulse signal as the transmission wave when the object is detected by other equipment.

13. An object detection method, comprising:
transmitting a long pulse signal, in which a pulse width is longer than a predetermined time, as a transmission wave, the transmission wave being an ultrasonic wave;
acquiring a received signal corresponding to a reflected wave reflected by an object of the transmission wave;
obtaining a fluctuation signal based on the received signal; and
detecting the object based on the fluctuation signal, wherein
the fluctuation signal is a signal corresponding to a composite wave generated when receiving the reflected wave and a wave which frequency is different from the reflected wave, or a signal generated by a phase change of the reflected wave when the distance to the object changes.
